(19) United States
(12) Patent Application Publication
(10) Pub. No.: US 2006/0031460 A1
(43) Pub. Date: Feb. 9, 2006

(54) Operation log cooperation utilizing device

(76) Inventors: Shouichi Araki, Osaka-shi (JP); Kutsumi Hiroshi, Moriguchi-shi (JP); Atsushi Yoshida, Neyagawa-shi (JP); Satoshi Matsuura, Kyotanabe-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/527,697

(22) PCT Filed: Nov. 11, 2003
(86) PCT No.: PCT/JP03/14297

§ 371 Date: Mar. 11, 2005

(30) Foreign Application Priority Data
Nov. 19, 2002 (JP) 2002-334643

(51) Int. Cl. G06F 15/173

(52) U.S. Cl. 709/224

(57) ABSTRACT

An operation log cooperation utilizing device 10 which enables a cooperation control on a plurality of devices using separately managed operation logs. The operation log cooperation utilizing device 10 (i) detects a user's operation on a device (101), (ii) accumulates and manages the detected operation as an operation log (102), and (iii) transmits a current operation log as a current operation log to other devices (103). On the other hand, the operation log cooperation utilizing device 10 (i) receives current operation logs from other devices (104), (ii) extracts, as associated operation logs, operation logs which are in predetermined relations to the received current operation logs (105), and (ii) transmits the extracted operation logs to other devices (106). Moreover, the operation log cooperation utilizing device 10 (i) receives associated operation logs from other devices (107), (ii) interprets the received associated operation logs (108), (iii) presents the user with the associated operation logs based on the interpretation result (109), (iv) determines the cooperating operation details for other devices based on the presented associated operation logs (110), and (v) transmits the determined cooperating operation details to the corresponding devices (111). Then, the operation log cooperation utilizing device 10 receives cooperating operation details from other devices (112), and provides the device control unit with the received cooperating operation details.

### TECHNICAL FIELD

The present invention relates to a cooperation method for devices (setting, control and information presentation) which are connected with each other via a network, the method being based on a user's use history that can be acquired from a plurality of devices.

### BACKGROUND ART

As a conventional system which controls each device so as to be put into a recommended operational state, based on a use history of the device, for example, Japanese Laid-Open Patent application No. 2002-203168 discloses a technique for controlling devices in which (i) use histories of a plurality of home appliances are accumulated into a bi-directional remote control, (ii) the accumulated use histories are transmitted, via a network, to a server having a function to analyze the user's hobby and taste, (iii) the server transmits, to the bidirectional remote control, as an analysis result of the use histories, “recommended information” matching the user's taste (for example, “recommended program” when the operational object is TV or video), and (iv) the user selects the “recommended information”. According to the above mentioned system, when a user selects a video as the operational object using the bi-directional remote control, a “recommended program” is displayed on the remote control, and a programmed recording of the TV program can be executed. Also, when a microwave oven is selected, a “recommended recipe” is displayed on the remote control, and a control command for the microwave oven can be transferred from the remote control.

However, as described above, while the conventional technique uses the use histories of the plurality of devices so as to generate the “recommended information”, presentation of the “recommended information” and device control are limited to the device selected as the operational object by the user. Thus, it is not possible to achieve cooperation between the devices according to the user's situation, such as activating a Personal Computer (PC) and preparing for a message transmission when the TV is turned off after a program ends.

### DISCLOSURE OF INVENTION

An object of the present invention, in view of the above mentioned problem, is to realize a cooperation control on a plurality of devices in which (i) each time an operation event for a device occurs, the associated operation logs are communicated with each other between the operation logs separately managed by the plurality of devices, thereby (ii) the associated operations between the devices can be discovered, and presented to the user.

In order to achieve the above mentioned object, the operation log cooperation utilizing device according to the present invention can use, in cooperation with the other devices, the user's operation logs accumulated in a pluarlity of devices, the device including: a device operation detection unit operable to detect a user's operation on a device; an operation log accumulation management unit operable to accumulate and manage the detected operation along with a predetermined attribute as an operation log; a current operation log transmission unit operable to transmit the current operation log as a current operation log to another device, the current operation log being accumulated when a user's operation is detected; a current operation log reception unit operable to receive the current operation log transmitted from another device; an associated operation log extraction unit operable to extract an operation log as an associated operation log from said operation log accumulation management unit, the operation log being in a predetermined relation to the received current operation log; an associated operation log transmission unit operable to transmit the extracted associated operation log to another device; an associated operation log reception unit operable to receive the associated operation log transmitted from another device; an associated operation log interpretation unit operable to interpret the received associated operation log using a predetermined operation log interpretation method; an associated operation log presentation unit operable to present the associated operation log to the user based on an interpretation result; a cooperating operation details determination unit operable to determine cooperating operation details for another device using a predetermined log processing method based on the presented associated operation log; a cooperating operation details transmission unit operable to transmit the determined cooperating operation details to a corresponding device; and a cooperating operation details reception unit operable to receive the cooperating operation details from another device.

Thus, (i) the operation logs are communicated with each other between the operation logs separately managed by the plurality of devices, (ii) the associated operations between the devices can be discovered and presented to the user, thereby (iii) the cooperating operation details specified by the user are transmitted to other devices. As a result, the cooperation control on the plurality of devices can be easily realized.

The present invention can be realized not only as the above mentioned operation log cooperation utilizing device, but also as (i) an operation log cooperation utilizing method having the components of the operation log cooperation utilizing device as steps, (ii) a program causing a computer to execute the steps, and (iii) a computer-readable recording medium in which the program is recorded.

### FURTHER INFORMATION ABOUT TECHNICAL BACKGROUND TO THIS APPLICATION

The disclosure of Japanese Patent Application No. 2002-334643 filed on Nov. 19, 2002 including specification, drawings and claims is incorporated herein by reference in its entirety.

### BRIEF DESCRIPTION OF DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing an overall structure example of a system according to the present invention;

FIG. 2 is a block diagram of an operation log cooperation utilizing device according to the first embodiment of the present invention;

FIG. 3 is a timing chart of an operation log cooperation according to the first embodiment of the present invention;

FIG. 4 is a flow chart showing details of the procedure 1 as shown in FIG. 3;

FIG. 5 is a flow chart showing details of the procedure 2 as shown in FIG. 3;

FIG. 6 is a flow chart showing details of the procedure 3 as shown in FIG. 3;

FIG. 7 is a diagram showing an example of an operation log descriptor;

FIG. 8 is a diagram showing an example of a current operation log transmitted when a digital television (DTV) is off;

FIG. 9 is a diagram showing an example of a PC operation log in the time period from nine PM to ten PM during the past one week;

FIG. 10 is a diagram showing an example of an MD compo operation log in the time period from nine PM to ten PM during the past one week;

FIG. 11 is a diagram showing an example of associated operation log transmission message (from a PC to a DTV) between devices;

FIG. 12 is a diagram showing an example of associated operation log transmission message (from an MD compo to a DTV) between devices;

FIG. 13 is a diagram showing an example of associated operation logs presented to a user;

FIG. 14 is a diagram showing an example of cooperating operation details (from a DTV to a PC);

FIG. 15 is a flow chart showing operations according to the second embodiment of the present invention;

FIG. 16 is a diagram showing an example of determining cooperating operation details according to the second embodiment of the present invention;

FIG. 17 is a flow chart showing operations according to the third embodiment of the present invention;

FIG. 18 is a diagram showing an example of determining cooperating operation details according to the third embodiment of the present invention;

FIG. 19 is a flow chart showing operations according to the fourth embodiment of the present invention;

FIG. 20 is a diagram showing an example of determining cooperating operation details according to the fourth embodiment of the present invention;

FIG. 21 is a block diagram of an operation log cooperation utilizing device according to the fifth embodiment of the present invention;

FIG. 22 is a flow chart showing operations according to the fifth embodiment of the present invention;

FIG. 23 is a block diagram of an operation log cooperation utilizing device according to the sixth embodiment of the present invention;

FIG. 24 is a flow chart showing operations according to the sixth embodiment of the present invention;

FIG. 25A and FIG. 25B are diagrams showing respective example of determining process for predicted cooperating operation details;

FIG. 26 is a block diagram of an operation log cooperation utilizing device according to the seventh embodiment of the present invention;

FIG. 27 is a timing chart showing operations of the seventh embodiment of the present invention;

FIG. 28 is a block diagram of an operation log cooperation utilizing device in a device having little hardware resource according to the eighth embodiment of the present invention;

FIG. 29 is a block diagram of an operation log cooperation utilizing device in a device having ample hardware resource according to the eighth embodiment of the present invention;

FIG. 30 is a block diagram of an operation log cooperation utilizing device having all the features of the first to eighth embodiments of the present invention; and

FIG. 31 is a block diagram of an operation log cooperation utilizing device according to a variation of the first embodiment of the present invention.

### BEST MODE FOR CARRYING OUT THE INVENTION

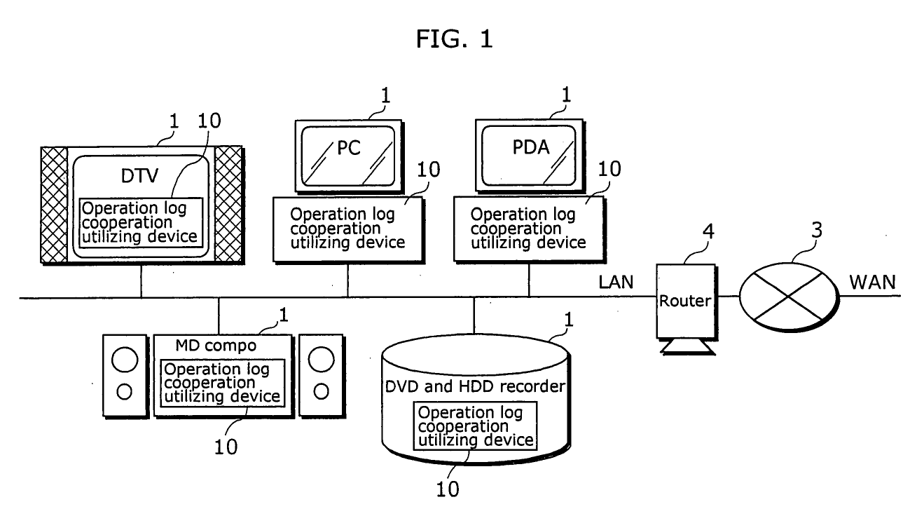

FIG. 1 is a block diagram showing an overall structure of the system according to the present invention. The present system comprises: home appliances 1 which can be connected via a network such as a Digital TV (DTV), a Personal Computer (PC), a Personal Digital Assistant (PDA), an MD compo, a Digital Versatile Disk (DVD) and Hard Disk Drive (HDD) recorder; a Local Area Network (LAN) 2 made up of cable or wireless networks; a Wide Area Network (WAN) 3 such as Internet; and a router 4 which connects the LAN 2 to the WAN 3. Using an operation log cooperation utilizing device 10, each of the home appliances 1 (i) accumulates and separately manages respective operation log, (ii) refers to each other's operation logs between a plurality of devices, and (iii) presents a user with candidates for a cooperating operation.

Hereinafter, the operation log cooperation utilizing device 10 implemented in the home appliances 1 will be explained. Each embodiment of the present invention realizes a technique which (i) grasps a user's life pattern in his ordinary life referring to operation logs of a plurality of devices, (ii) operates and sets each device so that the plurality of devices can be cooperated by understanding the user's situation (context) or intention on each occasion, and (iii) presents “recommended information”.

### First Embodiment

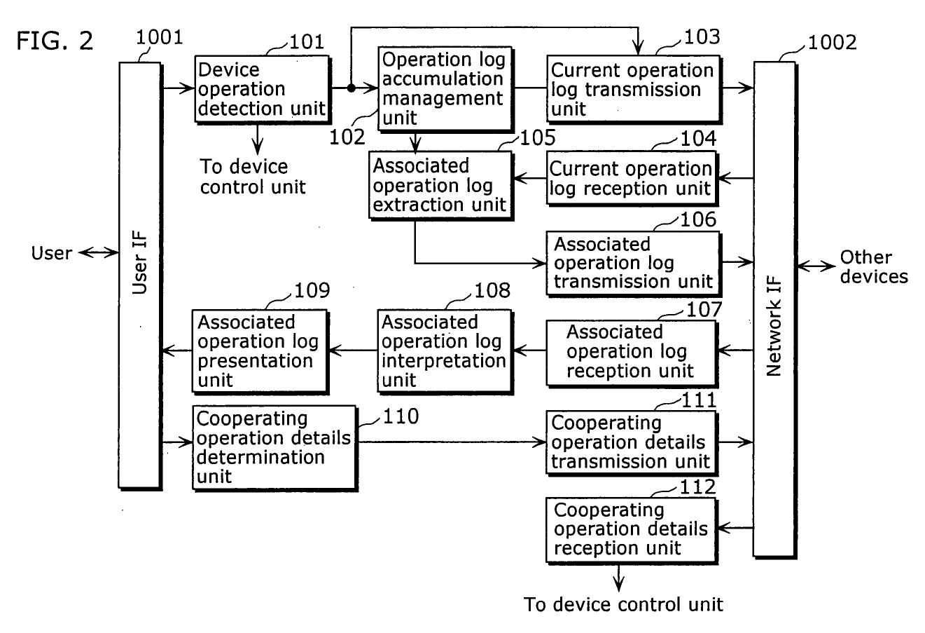

FIG. 2 is a block diagram of an operation log cooperation utilizing device 10 according to the first embodiment. The operation log cooperation utilizing device 10 comprises: a device operation detection unit 101 which detects a user's operation on each device; an operation log accumulation management unit 102 which accumulates and manages, as an operation log, the detected operation with a predetermined attribute; a current operation log transmission unit 103 which transmits a current operation log accumulated when detecting the user's operation, as a current operation log, to other devices that can communicate with each other; a current operation log reception unit 104 which receives each current operation log transmitted from other devices; an associated operation log extraction unit 105 which extracts, from the operation log accumulation management unit 102, as the associated operation log, an operation log that is in a predetermined relation to the received current operation log; an associated operation log transmission unit 106 which transmits the extracted associated operation log to other devices; an associated operation log reception unit 107 which receives each associated operation log transmitted from other devices; an associated operation log interpretation unit 108 which interprets the received associated operation log using a predetermined operation log interpretation method; an associated operation log presentation unit 109 which presents the user with the associated operation log based on the interpretation result; a cooperating operation details determination unit 110 which determines, based on the presented associated operation log, cooperating operation details for other devices, using a predetermined log processing method; a cooperating operation details transmission unit 111 which transmits the determined cooperating operation details to corresponding devices; a cooperating operation details reception unit 112 which receives the cooperating operation details from other devices; a user interface (IF) 1001 such as a remote control and a display; and a network IF 1002. The user IF 1001 includes a remote control equipped with a tablet, a software key board implemented in a PDA, and the like.

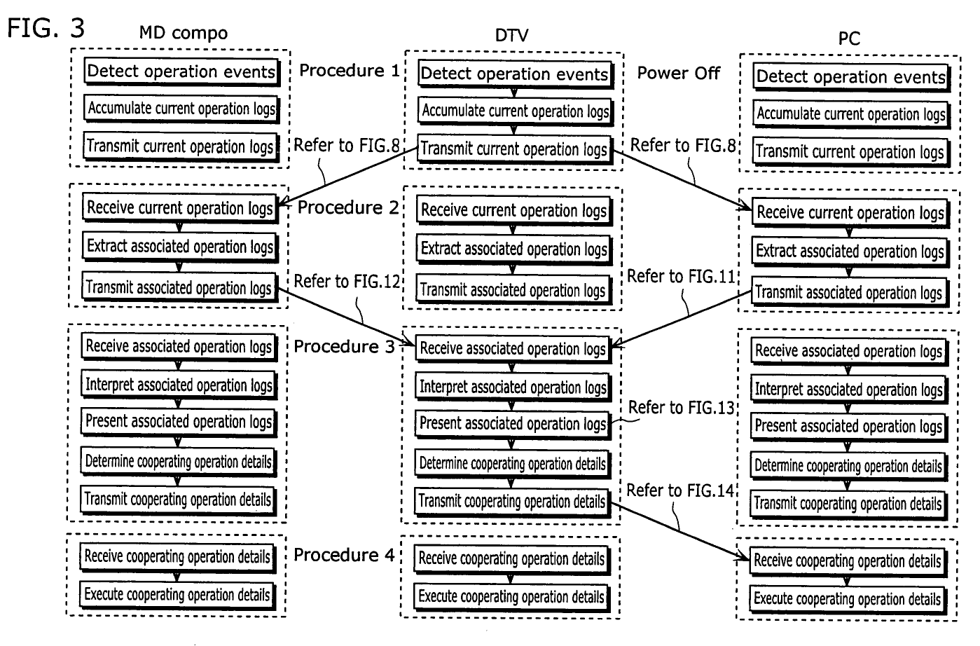

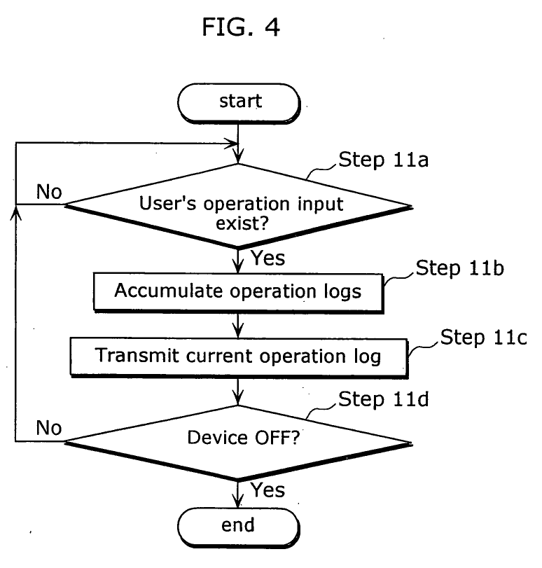

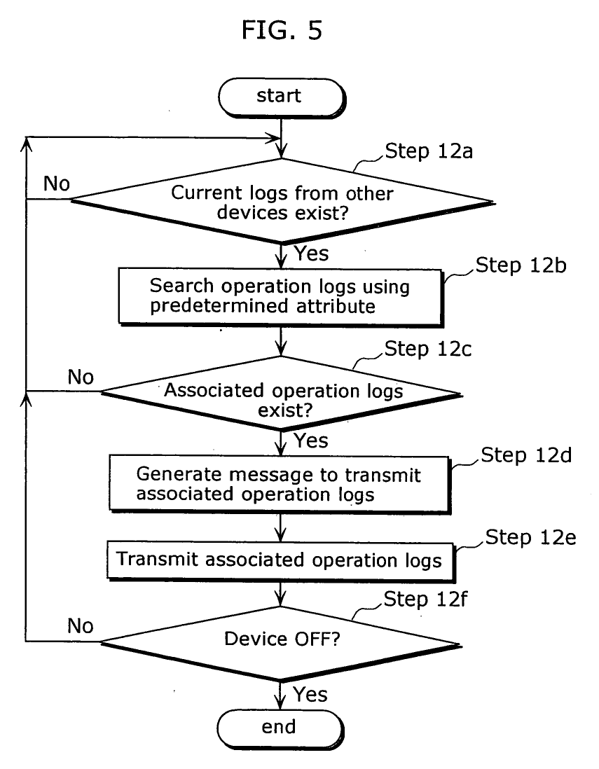

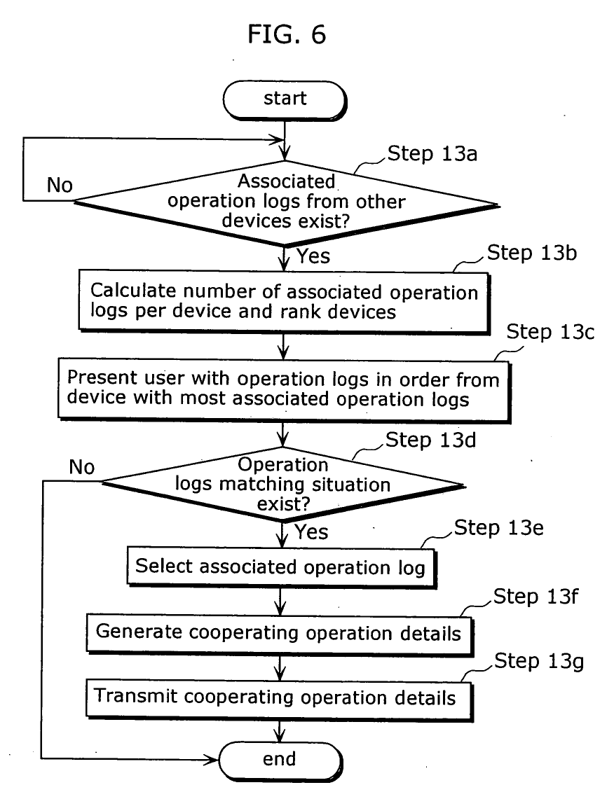

The operations of the first embodiment structured as described above will be explained using a timing flow chart of FIG. 3 and each flow chart of FIG. 4, FIG. 5 and FIG. 6. In order to explain the operations of the present embodiment more clearly, an example of a cooperating operation between a DTV, a PC and an MD compo will be explained here.

As shown in FIG. 3, the operations of the present embodiment include four procedures as follows.

Procedure 1: Notify other devices of a user's operation event;

Procedure 2: Receive operation events from other devices and return associated operation logs;

Procedure 3: After the user selectively processes a presented analysis result of the associated operation logs received from the other devices, cooperating operation details are transmitted to the cooperating devices; and

Procedure 4: The cooperating operation details are received and executed. The details of the above mentioned procedures will be explained referring to each flow chart of FIG. 4, FIG. 5 and FIG. 6.

First, the procedure 1 will be explained using the flow chart of FIG. 4. Here, an example of the DTV operation as shown in FIG. 3 will be explained.

Step 11a is a step of receiving operation input. The device operation detection unit 101 receives a user's operation. When input exists, the operation is proceeded to step 11b. When input does not exist, the device operation detection unit 101 continues to wait for operation input. Here, the DTV is switched off.

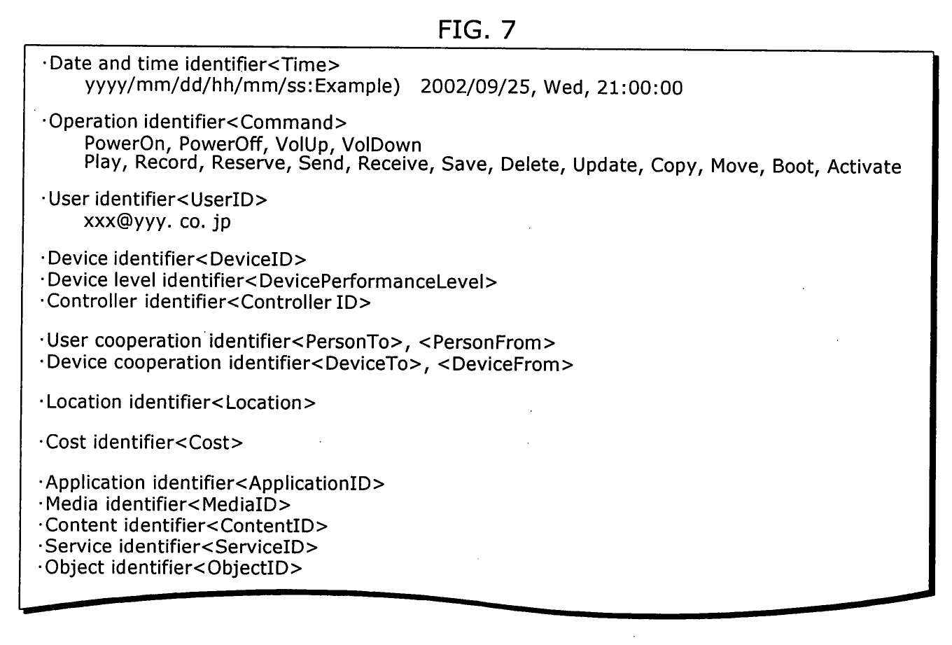

Step 11b is a step of accumulating operation logs. The operation log accumulation management unit 102 accumulates the operations received in the step 11a using a predetermined format. FIG. 7 is an example of a descriptor used for accumulating the operation logs. For example, at least one combination is used between: a date and time identifier; a device identifier; an operation identifier; a content identifier; an application identifier; a service identifier; and a user identifier.

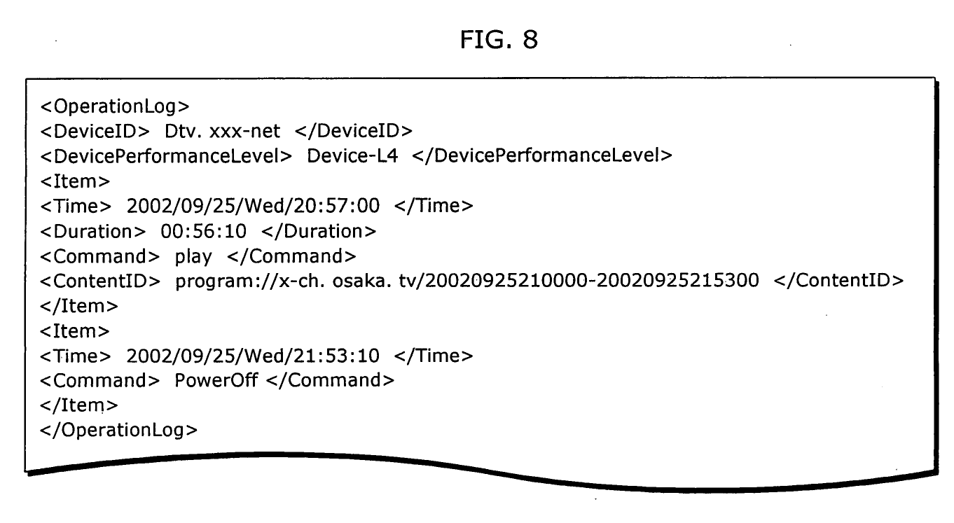

Step 11c is a step of transmitting a current operation log. The current operation log transmission unit 103 transmits a log associated with a current operation to the other devices. FIG. 8 shows an example of a log transmitted when the DTV is switched off.

Step 11d is a step of checking device power. Here, it is judged whether or not a device power is on or off. When the power is off, the step is ended. When the power is on, the operation goes back to the step 11a, and the user's input operation is waited.

Next, the procedure 2 will be explained using the flow chart of FIG. 5. Here, an example of the operations of the PC and the MD compo which receive the current operation log from the DTV will be explained.

Step 12a is a step of receiving current operation logs from other devices. The current operation log reception unit 104 receives current operation logs from the other devices. When the current operation log reception unit receives the operation logs, the operation is proceeded to step 12b. When the operation logs are not received, the current operation log reception unit waits for the current operation logs from the other devices. In this step, each of the PC and the MD compo receives the current operation log from the DTV.

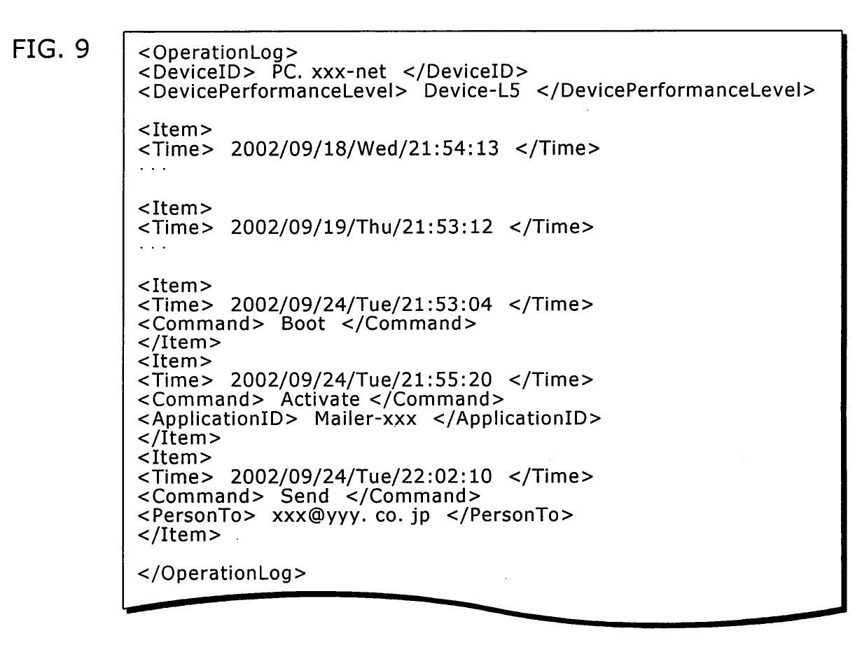

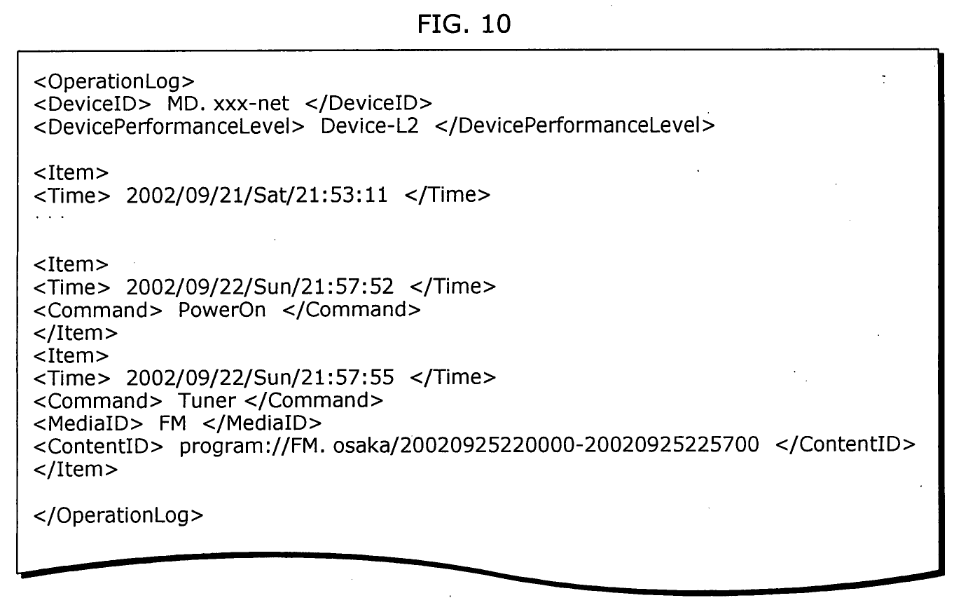

Step 12b is a step of searching an operation log using a predetermined attribute. The associated operation log extraction unit 105 extracts, from the operation logs (here, the operation logs accumulated in the PC and MD compo per se) accumulated in the operation log accumulation management unit 102, the operation logs associated with the current operation logs of the other devices received in the step 12a. Here, an example using “date and time” described under the date and time identifier as the predetermined attribute which indicates association will be explained. For example, the past operation history is searched, the history being accumulated in the operation log accumulation management unit 102 of the PC during a predetermined period (for example, during the time period from nine PM to ten PM in the past year) around the date and time when the operation is inputted into the DTV, that is, the time when the operation log received from the DTV is accumulated. FIG. 9 shows an example of the searched associated operation log. Similarly, FIG. 10 shows an example of the searched associated operation log for the MD compo.

Step 12c is a step of checking existence of an associated operation log. The associated operation log extraction unit 105 detects existence of the associated operation log, based on the search result in the step 12b. When the associated operation log exists, the operation is proceeded to step 12d. When the associated operation does not exist, the operation goes back to the step 12a, and the associated operation log extraction unit 105 waits for the current operation logs from the other devices.

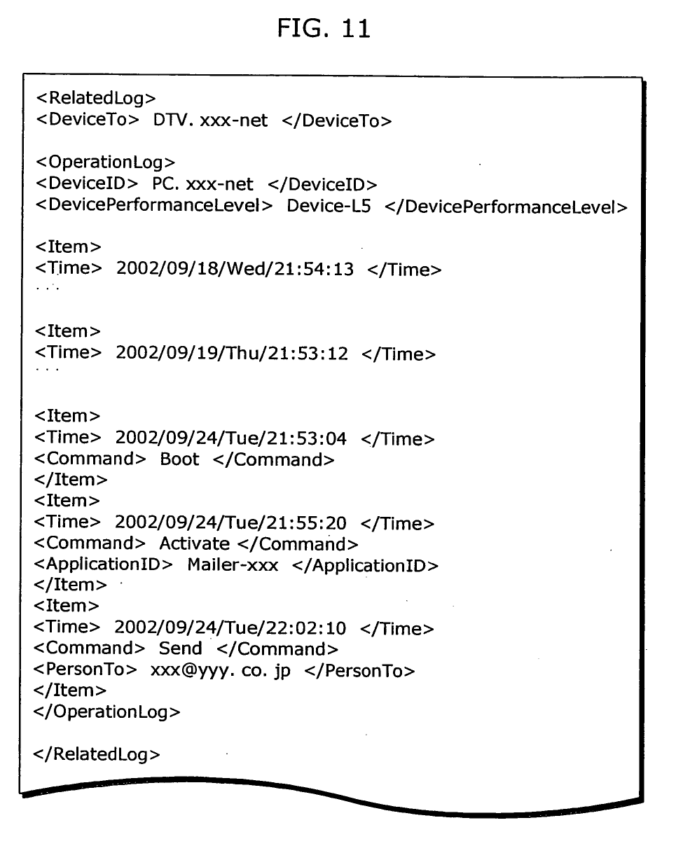

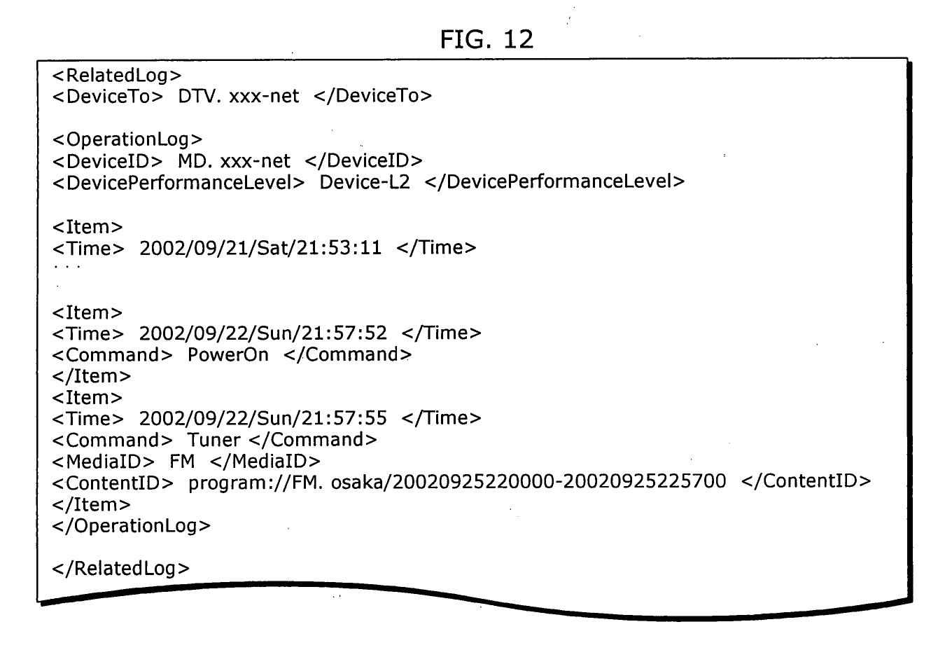

Step 12d is a step of generating a transmission message. The associated operation log extraction unit 105 generates a message to transmit the associated operation log to each of the devices that have transmitted the current operation log. Each of FIG. 11 and FIG. 12 shows an example of the message transmitted respectively from the PC and MD compo to the DTV.

Step 12f is a step of checking device power. Here, it is judged whether a device power is on or off. When the power is off, the step is ended. When the power is on, the process goes back to the step 12a, and the current operation logs are waited from other devices.

Next, the procedure 3 will be explained using a flow chart of FIG. 6. Here, an example of operations of the DTV which receives the associated operation logs from the PC and MD compo will be explained.

Step 13a is a step of receiving associated operation logs from the other devices. The associated operation log reception unit 107 (i) synchronizes with the current operation log transmission by the current operation log transmission unit 103, and (ii) receives the associated operation logs from the other devices during a predetermined period after the current operation log transmission. When the associated operation log reception unit 107 receives the associated operation logs within the predetermined period, the operation is proceeded to step 13b. When the associated operation logs are not received, the associated operation log reception unit 107 waits for a synchronization signal from the current operation log transmission unit 103. In this step, the DTV receives the associated operation logs from the PC and MD compo.

Step 13b is a step of calculating the number of associated operation logs. The associated operation log interpretation unit 108 (i) calculates, per device, the number of the associated operation logs received in the step 13a, and (ii) ranks the devices according to the operation frequency.

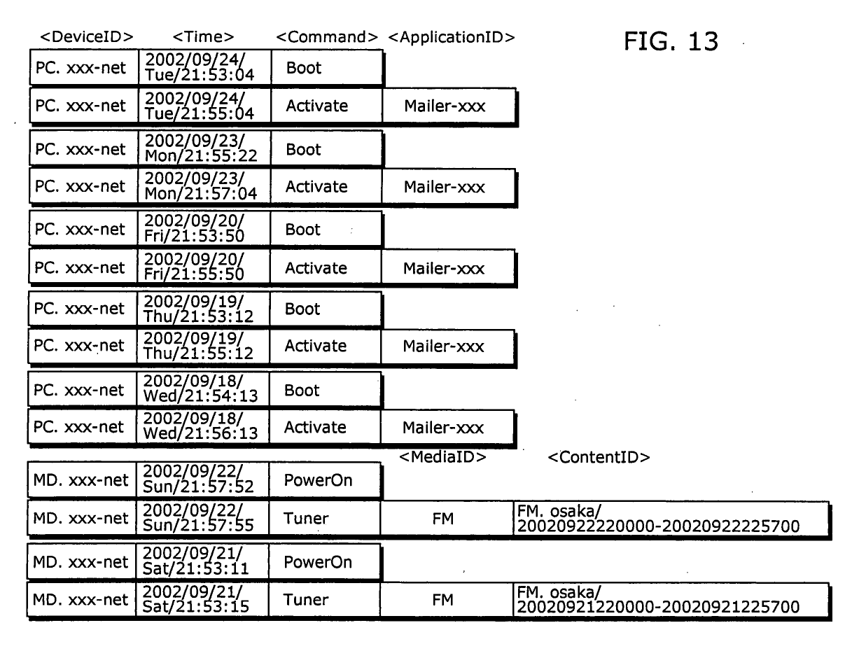

The step 13c is a step of presenting the user with the associated operation logs. The associated operation log presentation unit 109 presents, via the user IF 1001, the user with the received associated operation logs, according to the operation frequency rank order of the devices determined in the step 13b. FIG. 13 is an example of the associated operation logs presented to the user. The user activates the PC after nine fifty-three PM on weekdays, and operates the MD compo on Saturday and Sunday.

The step 13d is a step of checking existence of the operation logs which match the user's situation. The user checks whether the operation logs which match his current situation exist among the associated operation logs presented in the step 13c. In other words, the user checks whether the operation which he attempt to execute exists. When such attempted operation exists, the operation is proceeded to step 13e. When such attempted operation does not exist, the present procedure is ended.

Step 13e is a step of selecting the associated operation log. When the user finds the log of the operation which he attempts to execute among the presented associated operation logs, the user selects the corresponding associated operation log using the user IF 1001. Here, since the current time is on a weekday, it is assumed that the user selects activating a boot and mailer of the PC.

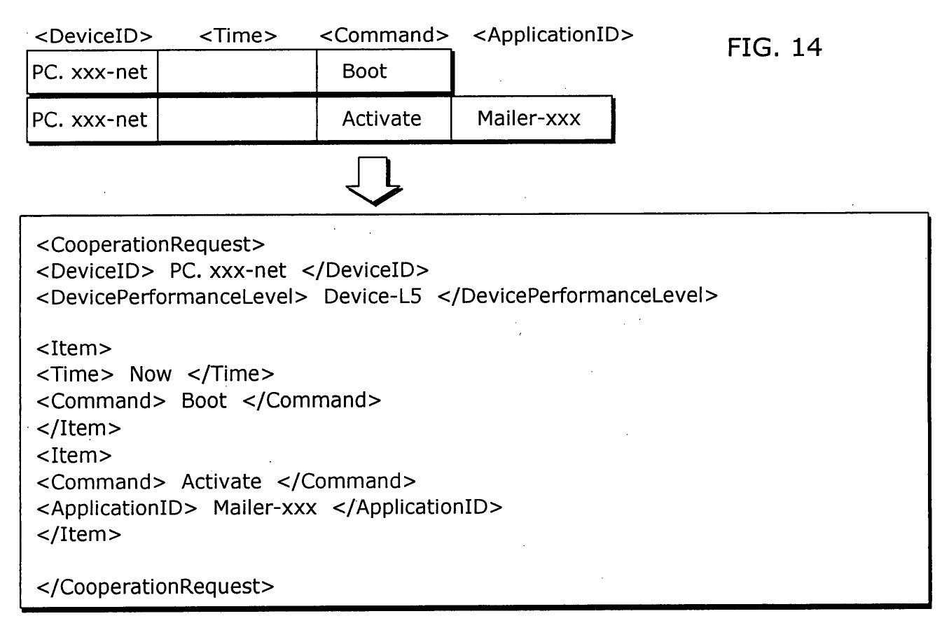

Step 13f is a step of generating cooperating operation details. The cooperating operation details determination unit 110 generates a message indicating the cooperating operation details to a device which a cooperating operation is requested to, based on the associated operation log selected in the step 13e. For example, as shown in FIG. 14, a message transmitted from the DTV to the PC is generated. Here, the cooperating operation details are that the PC is booted, and the mailer is activated.

Step 13g is a step of transmitting the cooperating operation details. The cooperating operation details transmission unit 111 transmits the cooperating operation details generated in the step 13f to the corresponding device.

Finally, the procedure 4 will be explained. Here, an example of the operations executed in the case where the PC receives the message indicating the cooperating operation details from the DTV will be explained. The cooperating operation details reception unit 112 receives the message indicating the cooperating operation details from the counter device to which the associated operation log has been transmitted. The received message is transmitted to the device control unit, and executed. In the example of FIG. 14, after the PC is booted, the mailer is activated.

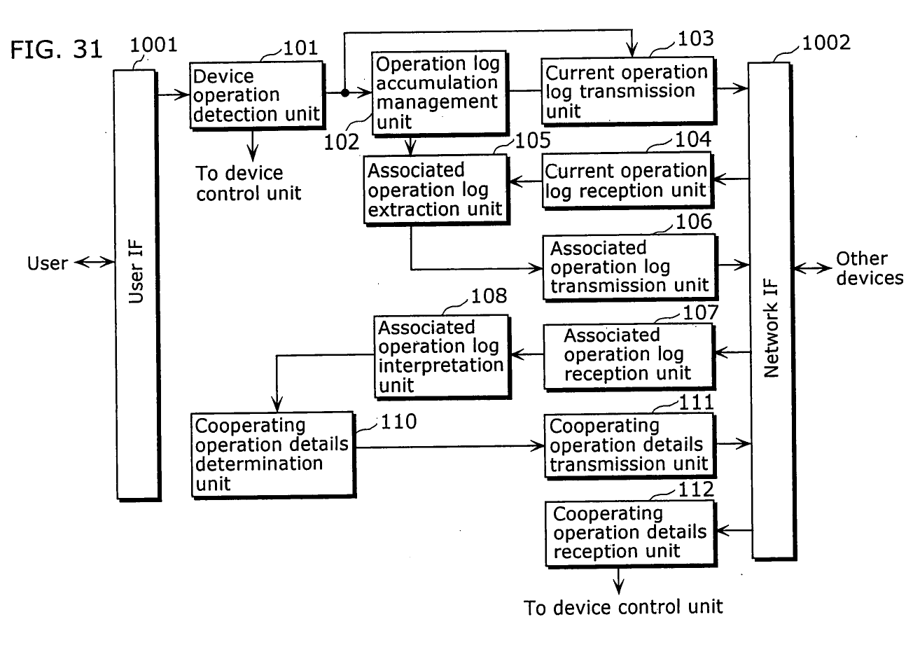

Here, from the step 13c to the step 13e according to the present embodiment, the associated operation logs are presented to the user, and the user selects the associated operation logs. However, the user does not necessarily have to execute the selection. For example, the present invention may be structured as shown in FIG. 31, and the cooperating operation details determination unit 110 may execute control so that the associated operation logs ranked by the operation frequency in the step 13b are automatically selected and transmitted, to the other devices, by the device according to the similarities such as the operation frequency, day and time.

As described in the above procedures 1 to 4, according to the first embodiment, each time an operation event for a device occurs, the associated operation logs are communicated with each other between the operation logs separately managed by the plurality of devices. Thereby, the associated operations between the devices can be discovered, and presented to the user. Thus, the cooperation of the plurality of devices can be easily controlled.

Specifically, associations of the operations are extracted from the operation logs of the plurality of devices, and the operation logs are used for the associated control. Since the user always activates the PC and sends a message to his friend after watching a drama on the DTV at nine PM on weekdays, when the user turns off the DTV after the drama starting at nine PM ends, the PC is activated in cooperation with such situation. Thus, the device cooperation associated with the user's situation can be realized.

### Second Embodiment

According to the second embodiment, when the associated operation logs are presented to the user, the logs are grouped depending on the appearance frequency of attribute value, and then presented to the user. Therefore, compared to the first embodiment, the cooperating operation details are more easily determined.

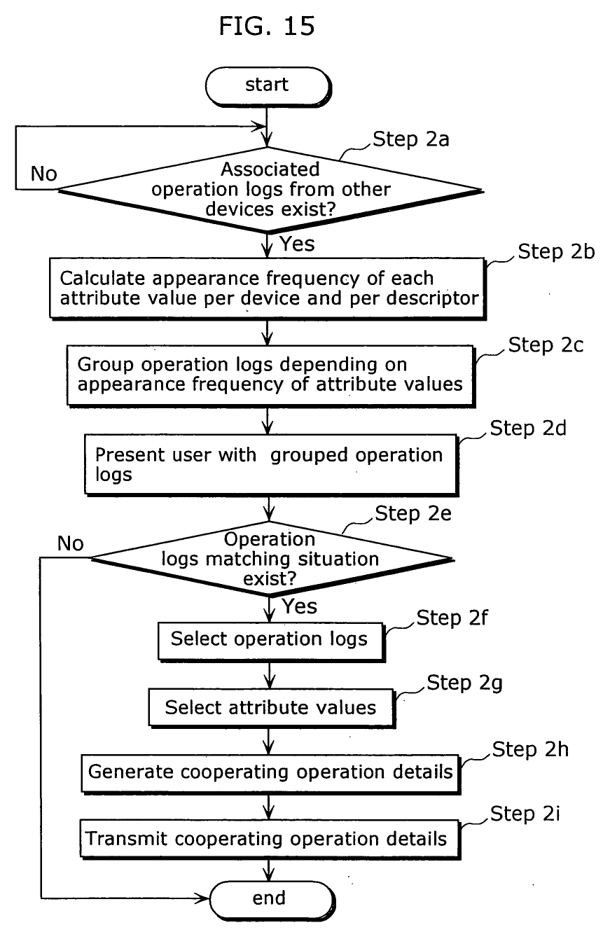

The operations of the second embodiment will be explained using a flow chart of FIG. 15 as follows. Here, only the procedure 3 is different from the first embodiment among the four procedures included in the first embodiment, only the procedure 3 will be explained using the flow chart of FIG. 15.

Step 2a is a step of receiving the associated operation logs from the other devices. The associated operation log reception unit 107 synchronizes with the transmission of the current operation logs by the current operation logs transmission unit 103, and receives the associated operation logs from the other devices for a predetermined period after the transmission of the current operation logs. When the associated operation log reception unit 107 receives the associated operation logs within the predetermined period, the operation is proceeded to step 2b. When the associated operation logs are not received, the associated operation log reception unit 107 waits for a synchronization signal from the current operation log transmission unit 103.

Step 2b is a step of calculating the appearance frequency of attribute value. The associated operation log interpretation unit 108 calculates the appearance frequency of each attribute value per device and per descriptor.

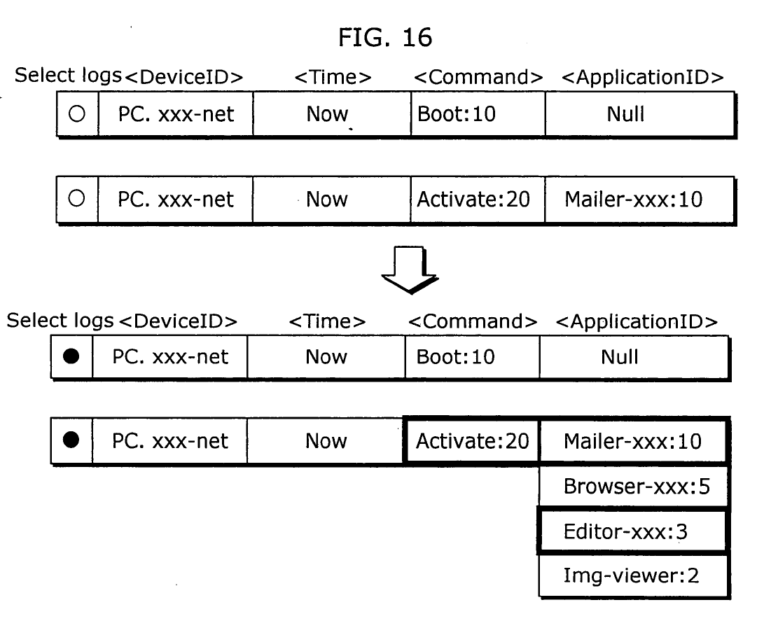

Step 2c is a step of grouping operation logs depending on the appearance frequency of attribute values. The associated operation log interpretation unit 108 ranks attributes depending on the appearance frequency, and groups the ranked attributes as shown in FIG. 16. In the example of FIG. 16, the operation logs of the PC are grouped by attributes such as boot (PC activation) or activate (application activation). The numbers shown to the right of the attribute values indicate the occurrence frequency of the attribute values. In this example, the user activates the application twenty times in the past one week: mailer ten times; browser five times; editor three times; and image viewer twice.

Step 2d is a step of presenting the user with the grouped associated operation logs. The associated operation log presentation unit 109 presents the user with the associated operation logs grouped in the step 2c via the user IF 1001.

Step 2e is a step of checking existence of the operation logs matching the user's situation. The user checks whether the operation logs matching his current situation exist among the grouped associated operation logs presented in the step 2d. In other words, the user checks whether the operation which he attempts to execute exists. When such attempted operation exists, the operation is proceeded to step 2f. When such attempted operation does not exist, the present procedure is ended.

Step 2f is a step of selecting associated operation logs. When the operation which the user attempts to execute exists among the grouped associated operation logs presented in the step 2d, the user selects the corresponding associated operation logs using a cursor operation of the user IF 1001 and the like. For example, as shown in the white circles (non-selection) and black circles (selection) in FIG. 16, selection of the associated operation logs can be realized by the interface such as a check box.

Step 2g is a step of selecting attribute values of the associated operation logs. When the attribute values of the operations which the user attempts to execute exist in the grouped associated operation logs presented in the step 2d, the user selects the corresponding attribute values using the cursor operation in the user IF1001 and the like. For example, in FIG. 16, the operation logs are grouped per attribute value of application identifier. The grouped attribute values are displayed in the order of occurrence frequency like a pull-down menu. Thus, it is possible to easily select the applications which the user used in the other devices in the current time period in the past. In the example of FIG. 16, as marked by the heavy lines, mailer (Mailer-xxx) and editor (Editor-xxx) are selected.

Step 2h is a step of generating associated operation details. The cooperating operation details determination unit 110 generates a message indicating the cooperating operation details to the device which the cooperating operation is requested to, based on the associated operation logs and attribute values selected in the steps 2f and 2g.

Step 2i is a step of transmitting the cooperating operation details. The cooperating operation details transmission unit 111 transmits the cooperating operation details generated in the step 2h to the corresponding device. Here, from the DTV to the PC, the PC boot and the activation of the mailer and the editor are transmitted as the cooperating operation details.

As described above, according to the second embodiment, when the associated operation logs are presented to the user, the logs are grouped depending on the appearance frequency of the attribute values, and then the grouped logs are presented to the user. Thus, the user can easily specify the attribute values, and the cooperating operation details can be easily determined.

From the step 2d to the step 2g according to the present embodiment, the grouped associated operation logs are presented to the user, and the user selects the associated operation logs and the attributes. However, the user does not necessarily have to select the attributes. For example, depending on the operation frequency calculated in the step 2c, the associated operation logs and the attributes may be automatically selected by the device, and transmitted to the other devices, so as to execute control.

### Third Embodiment

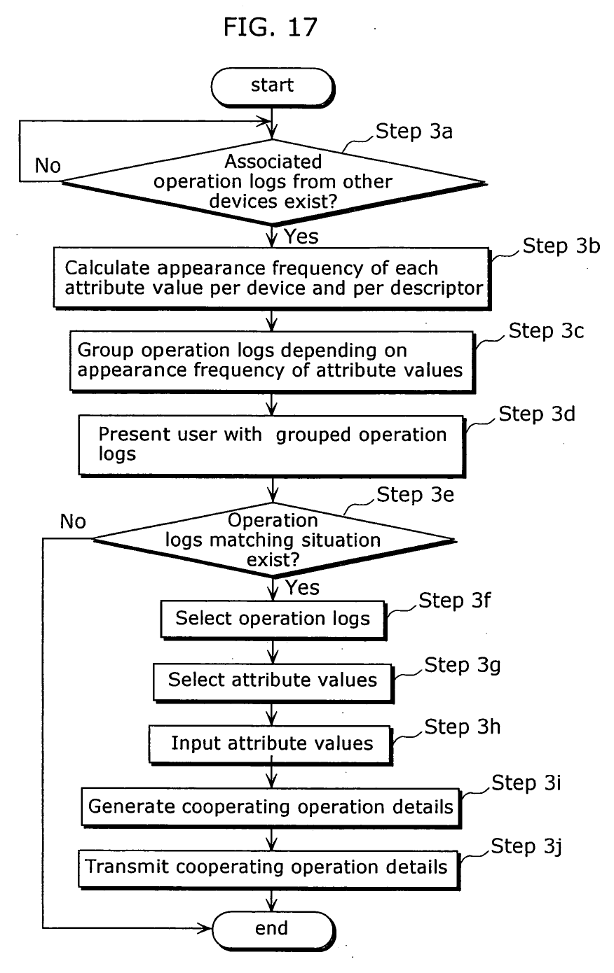

In the third embodiment, the user can freely change the attribute values of the associated operation logs collectively presented to the user per device, and the user can freely edit the presented attribute values of the associated operation logs, and describe the associated operation details. The operations of the third embodiment will be explained using a flow chart in FIG. 17 as follows. However, only the step 3h which is different from the flow chart of FIG. 15 that displays the operations of the second embodiment will be explained among the steps 3a, 3b, 3c, 3d, 3e and 3f as shown in FIG. 17.

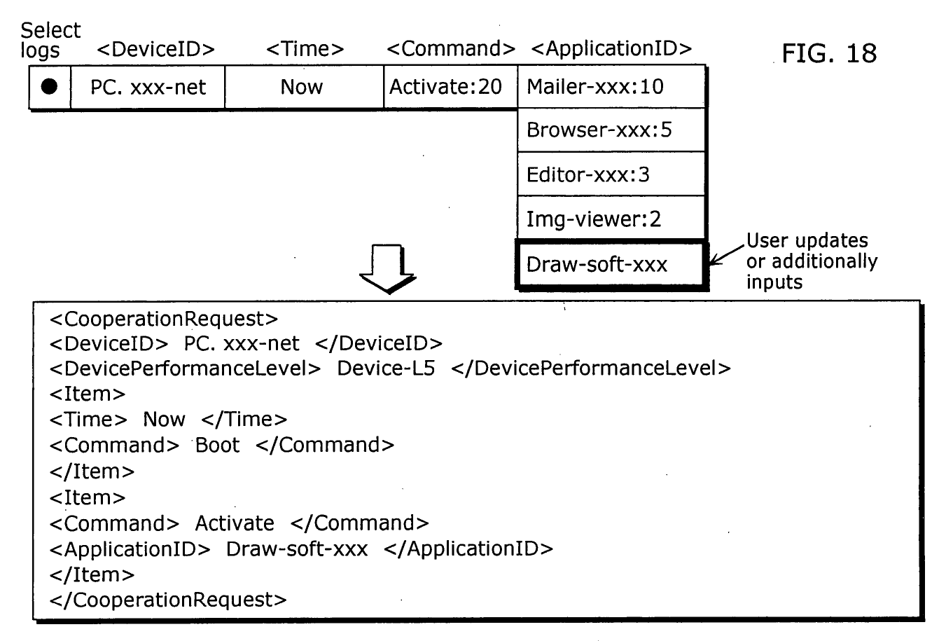

The step 3h is a step of inputting attribute values. In the case where among the associated operation logs presented in the step 3d, there are ones which can be used as the cooperating operation details when the attribute values are updated, such updated attribute values are inputted using the user IF 1001. FIG. 18 shows an example in which the user (i) attempts to activate, in cooperation, “Draw-soft-xxx” that has not been operated in the current time period, (ii) selects the logs, and (iii) additionally inputs the attribute values for <Application ID>. Thereby, the cooperating operation details as shown in the bottom part of FIG. 18 are generated and transmitted to the PC which is the cooperating device.

As described above, according to the third embodiment, since the user can freely change the attribute values of the associated operation logs presented to the user, the device cooperation can be freely set extemporarily.

As the user's method for additionally inputting the attribute values, there are: (1) the method in which the user directly specifies the attribute values; and (2) the method in which (i) the current operation log reception unit 104 and the associated operation log reception unit 107 accumulate the received operation logs, (ii) the associated operation log presentation unit 109 or the cooperating operation details determination unit 110 presents the attribute values included in the accumulated operation logs to the user, and (iii) the user additionally inputs the selected attribute values.

### Fourth Embodiment

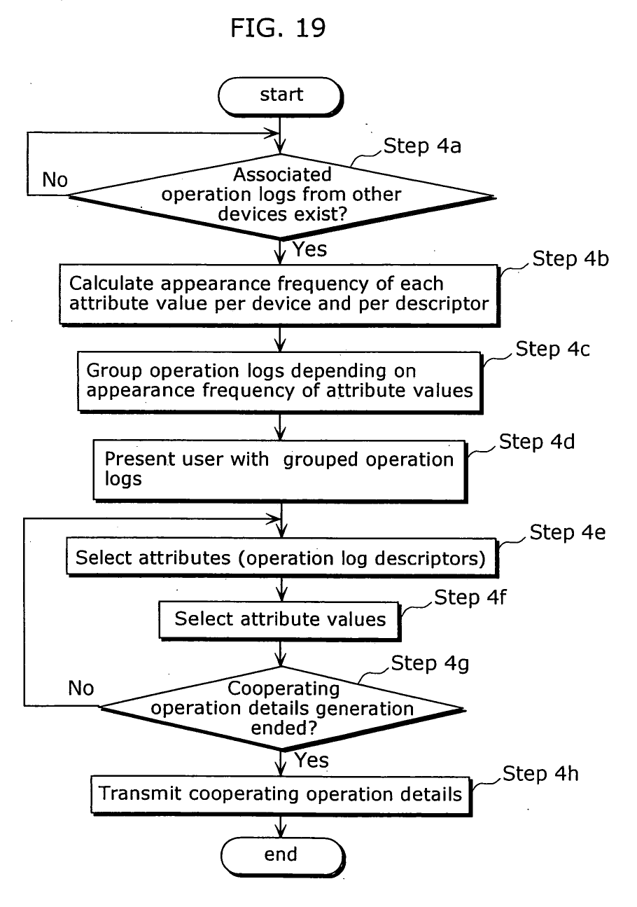

In the fourth embodiment, a plurality of attribute values are combined so that the user can easily generate the cooperating operation details. The user can easily generate the cooperating operation details simply by selecting the attribute values, for arbitrary attributes, from a pull-down menu generated based on the associated operation logs. The operations of the fourth embodiment will be explained using a flow chart of FIG. 19 as follows. However, among the steps 4a, 4b, 4c, 4d, 4e, 4f, 4g and 4h as shown in FIG. 19, only the steps 4e, 4f and 4g which are different from the flow chart of FIG. 15 displaying the operations of the second embodiment will be explained.

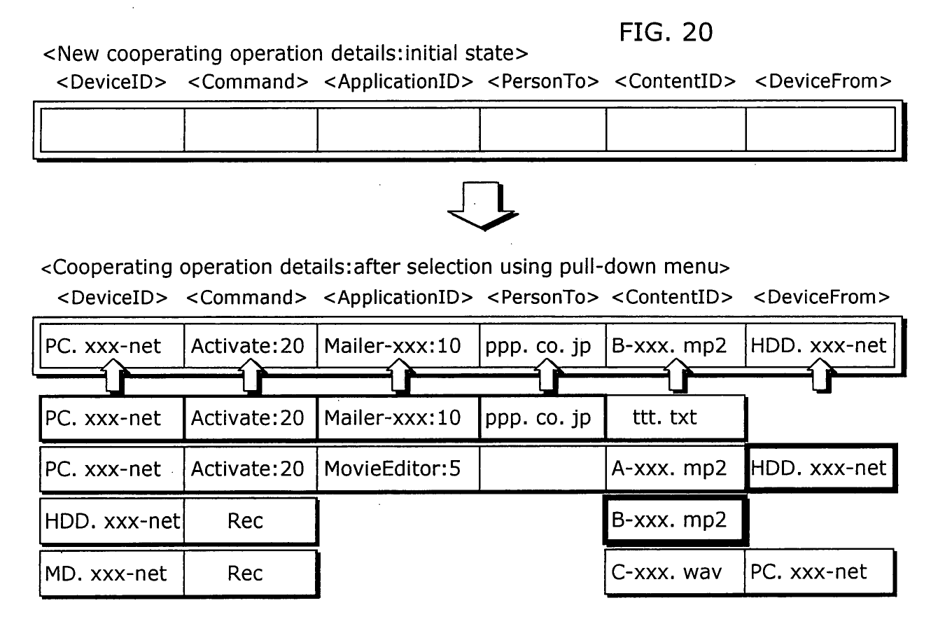

The step 4e is a step of selecting attributes (operation log descriptors). In <New cooperating operation details: initial state> as shown in FIG. 20, the user selects the attributes using the cursor operation and the like of the user IF 1001. For example, in FIG. 20, when the attribute <Device ID> is selected, as the pull-down menu, “PC. xxx-net”, “HDD. xxx-net” and “MD. xxx-net” are displayed. These displays are made by referring to the attribute value of the attribute <Device ID> of the associated operation log transmitted from the other devices.

The step 4f is a step of selecting attribute values. The user selects the attribute values displayed in the step 4e using the cursor operation and the like of the user IF 1001. For example, in FIG. 20, “PC. xxx-net” is selected.

The step 4g is a step of judging generation end of the cooperating operation details. The user repeats the steps 4e and 4f till the attributes and attribute values desired to be specified disappear. When the user indicates ending the cooperating operation details using the user IF 1001 (for example, pushing end button or clicking end Graphical User Interface (GUI)), the generated cooperating operation details are transmitted to the cooperating devices in the step 4h. In the example of FIG. 20, a message is generated so as to transmit content (B-xxx. mp2) recorded in a hard disk recorder (HDD. xxx-net) to a person “ppp. co. jp” to whom a message has been sent.

As described above, according to the fourth embodiment, the user can easily generate the cooperating operation details simply by selecting the attribute values, for the arbitrary attributes, from the pull-down menu generated based on the associated operation logs.

Here, as the method for presenting the user with a list of selectable attribute values, there are: (1) a method in which the associated operation log presentation unit 109 lists and displays a plurality of stored attribute values; and (2) a method in which (i) the current operation log reception unit 104 or the associated operation log reception unit 107 accumulates the received operation logs, and (ii) the associated operation log presentation unit 109 lists the attribute values included in the accumulated operation logs so as to present to the user.

### Fifth Embodiment

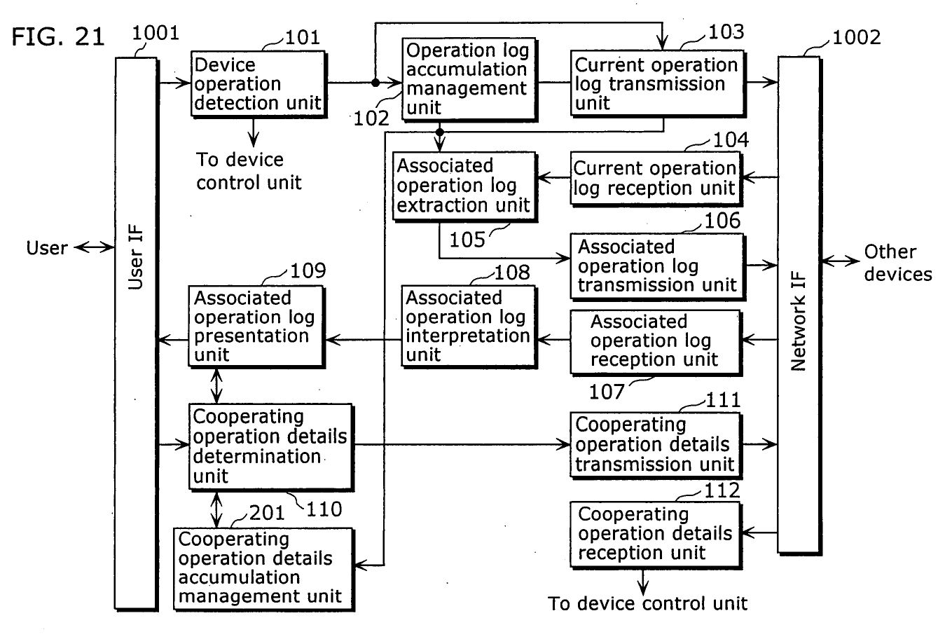

In the fifth embodiment, the cooperating operation details which the user selected in the past can be used for the current operation logs. FIG. 21 shows a structure diagram of the fifth embodiment. The difference from the first embodiment as shown in FIG. 2 is that the there is an additional cooperating operation details accumulation management unit 201 which associates the current operation logs with the cooperating operation details determined by the user, and accumulates the associated information.

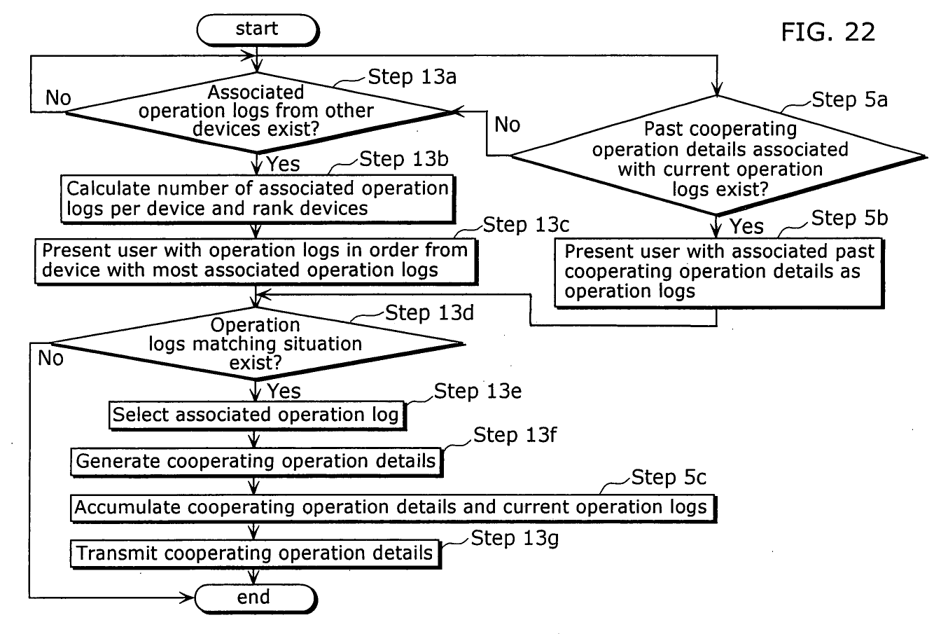

The operations of the fifth embodiment structured as described above will be explained using a flow chart of FIG. 22. However, only the steps 5a, 5b and 5c which are different from the flow chart of FIG. 6 will be explained.

The step 5a is a step of checking the past cooperating operation details. The cooperating operation details accumulation management unit 201 (i) synchronizes with the transmission of the current operation logs by the current operation log transmission unit 103, and (ii) extracts the cooperating operation details associated with the current operation logs from the cooperating operation details accumulation management unit 201. Such extraction can be based on (partial) correspondence of the attribute values of the operation log descriptors. When the associated cooperating operation details exist, the operation is proceeded to step 5b. When the associated cooperating operation details do not exist, the cooperating operation details accumulation management unit 201 waits for the associated operation logs from the other devices in the step 13a.

The step 5b is a step of presenting the associated past cooperating operation details to the user. The associated operation log presentation unit 109 presents the user with the past cooperating operation details associated with the current operation logs which were extracted by the cooperating operation details accumulation management unit 201, as the operation logs shown in FIG. 13, using the GUI. Then, the operation is proceeded to the step 13d of the user's selecting the associated operation logs.

The step 5c is a step of accumulating the cooperating operation details and current operation logs. The cooperating operation details accumulation management unit 201 associates the associated operation details selected and generated in the steps 13d, 13e and 13f with the current operation logs, and accumulates the associated information. After the above accumulation, the cooperating operation details are transmitted to the cooperating devices in the step 13g.

As described above, according to the fifth embodiment, the current operation logs and the cooperating operation details determined by the user are associated with each other and stored. Thereby, the cooperating operation details selected by the user in the past can be easily selected in association with the current operation. Thus, device cooperation can be realized more easily and certainly.

Needless to say, by accumulating the number of times which the user selects the cooperating operation details into the cooperating operation details accumulation management unit 201, the cooperating operation details can be clearly presented to the user according to the selection number.

Also, the user does not necessarily have to select the cooperating operation details. For example, the device may automatically select the cooperating operation details according to the past selection number and the like, and transmits to the other devices so as to execute control.

### Sixth Embodiment

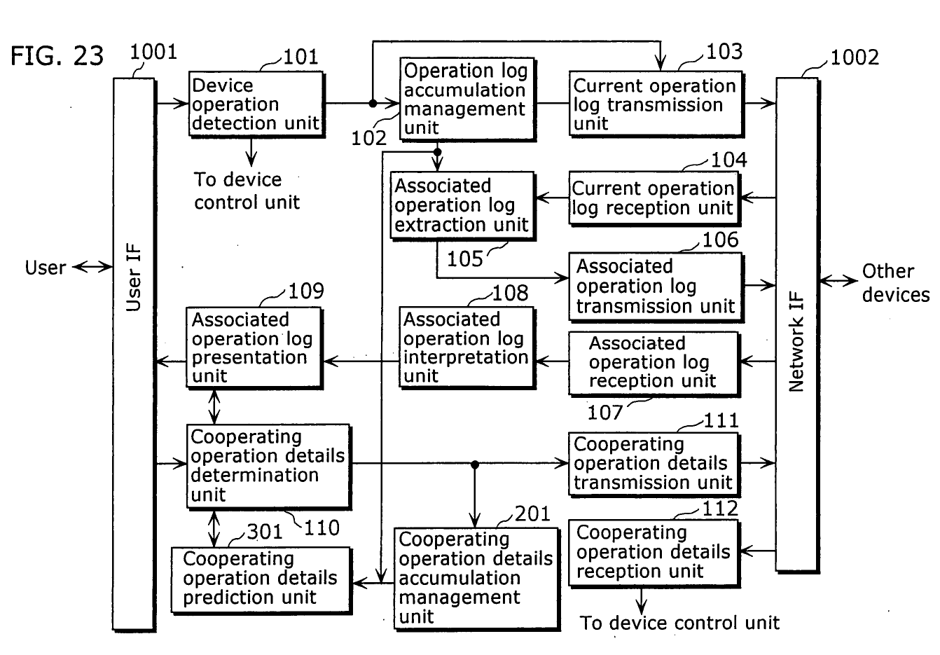

In the sixth embodiment, the user's operation on devices following the current operation logs are predicted and the cooperating operation details are presented. Thereby, the cooperating operation details can be specified more easily. A structure diagram of the sixth embodiment is shown in FIG. 23. The difference from the fifth embodiment as shown in FIG. 21 is that there is an additional cooperating operation details prediction unit 301 which predicts the user's next cooperating operation details based on (i) the associated operation logs received from the other devices and/or (ii) the cooperating operation details and the current operation logs accumulated in the cooperating operation details accumulation management unit 201.

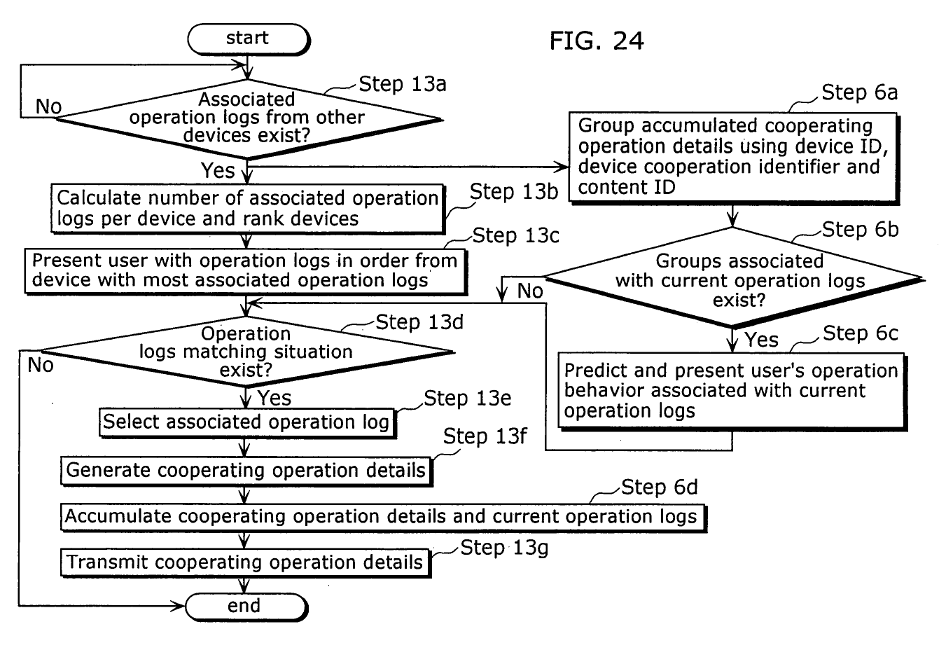

The operations of the sixth embodiment structured as described above will be explained using a flow chart of FIG. 24. However, among the steps 6a, 6b, 6c and 6d in FIG. 24, only the steps 6a, 6b and 6c which are different from the flow chart of FIG. 22 displaying the operations of the fifth embodiment will be explained.

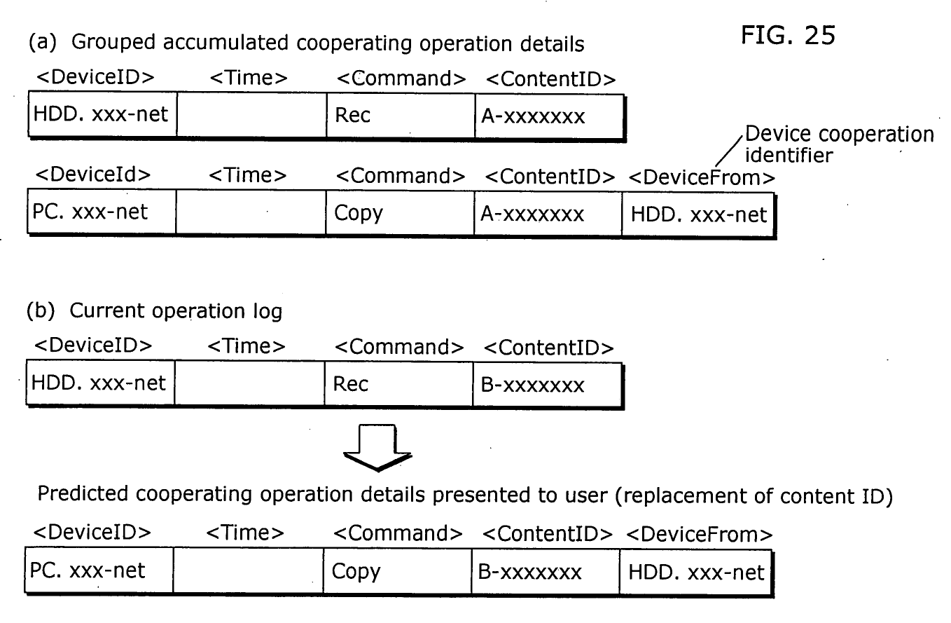

The step 6a is a step of grouping the associated operation logs. The cooperating operation details prediction unit 301 groups the cooperating operation details accumulated in the cooperating operation details accumulation unit 201 using predetermined attribute combinations. For example, such grouping is executed using the combinations of the attribute values included in a device identifier <Device ID>, a device cooperation identifiers <Device From> and <Device To>, and a content identifier <Content ID>. In the example of FIG. 25A, the cooperating operation details are grouped, the details sharing the common attribute values of the <Content ID> as “A-xxxxxx”, and the common attribute values of the <Device ID> and <Device From> as “HDD. xxx-net”.

The step 6b is a step of specifying a group associated with the current operation logs. The cooperating operation details prediction unit 301 specifies the grouped cooperating operation details sharing the common attribute values for the <Device ID> and <Command> of the current operation logs. When groups sharing the common attribute values exist, the operation is proceeded to the step 6c. When groups sharing the common attribute values do not exist, the operation is proceeded to the step 13d.

The step 6c is a step of predicting and presenting the user's operation behavior. For example, the cooperating operation details prediction unit 301 replaces <Content ID> of the cooperating operation details specified in the step 6b with that of the current operation logs. “A-xxxxxx” of <Content ID> in FIG. 25A is replaced with “B-xxxxxx” in FIG. 25B. In other words, since there is a history that in the past after the user recorded the content “A-xxxxxx” in the HDD recorder, he copied the recorded content into the PC, in the case where the event of recording content “B-xxxxxx” occurs, it is predicted that the recorded content would be copied into the PC. After the prediction result is presented to the user, the steps 13d to 13g are executed.

As described above, according to the sixth embodiment, the associated operation logs and the past cooperating operation details which have been received from the other devices are grouped using the predetermined attributes. And, by replacing the attribute values that are different between the grouped associated operation logs and the current operation logs, the user's next operation behavior is predicted. Thus, the cooperating operation of devices can be more easily realized.

In the step 6c of the present embodiment, the prediction result is presented to the user, and the user selects the cooperating operation details. However, the user does not necessarily have to select the cooperating operation details, and the prediction result may be transmitted to the other devices as it is, so as to execute control.

### Seventh Embodiment

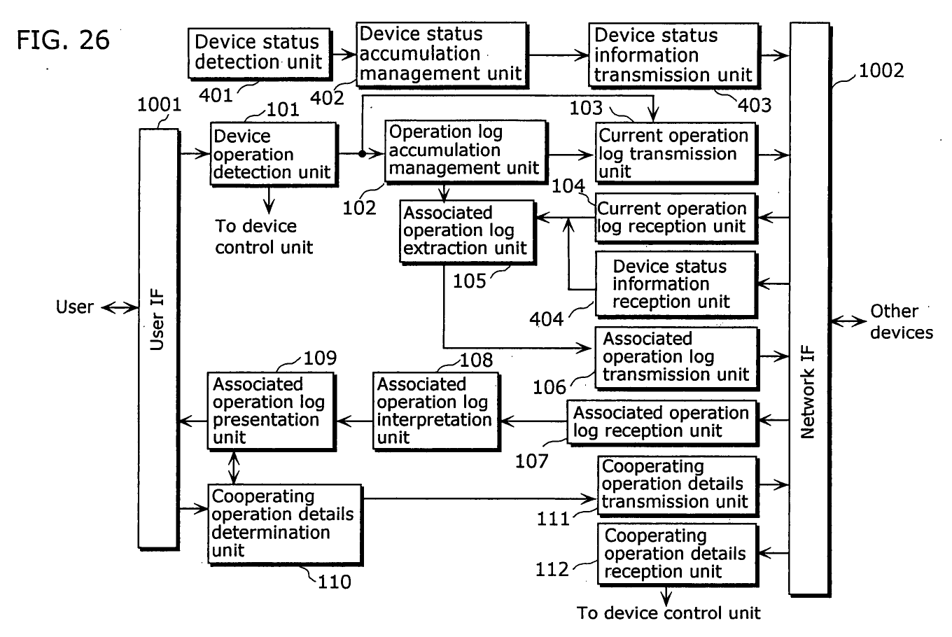

In the seventh embodiment, status change of the device is detected, and a service is provided according to what the user is currently doing depending on the status change. FIG. 26 shows a structure diagram of the seventh embodiment. The difference from the first embodiment as shown in FIG. 2 is that the following units are added: a device status detection unit 401 which detects the device status in predetermined timings; a device status accumulation management unit 402 which accumulates and manages the device status information regarding the detected status; a device status information transmission unit 403 which transmits the device status information to the other devices; and a device status information reception unit 404 which receives device status information from the other devices.

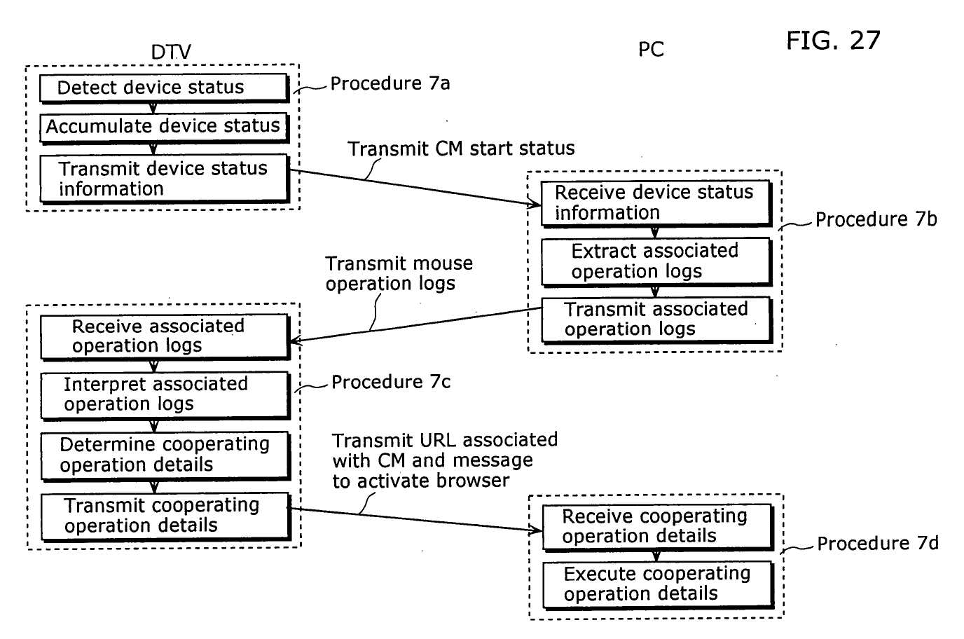

The operations of the seventh embodiment structured as described above will be explained using a timing chart of FIG. 27. In an example of FIG. 27, the procedures 7a and 7c are executed by the DTV, and the procedures 7b and 7d are executed by the PC.

First, in the procedure 7a, (i) a change of the device status is detected by the device status detection unit 401 and device status accumulation management unit 402, and then (ii) the device status and status change are notified to the other devices by the device status information transmission unit 403 in predetermined timings. Here, a Commercial Message (CM) start is detected by the DTV, and the status information is transmitted to the PC. The CM start is detected, in a simple case, by detecting a change from monophonic signals to stereo signals.

In the procedure 7b, the device status information reception unit 404 receives status information (here, the CM start information) transmitted from the other devices. Using the reception of the status information as the trigger, the associated operation log extraction unit 105 of the PC extracts operation logs from the operation log accumulation management unit 102, and returns the operation logs to the DTV. Here, for example, the extracted operation logs are the operation logs of the mouse, and the mailer is activated at the same time.

In the procedure 7c, the associated operation log reception unit 107 receives the mouse operation logs from the PC. The cooperating operation details determination unit 110 of the DTV judges that while watching TV, when the TV program switches to a CM, the user checks messages by operating the mouse. Then, the cooperating operation details determination unit 110 transmits, to the PC, the Uniform Resource Locator (URL) of the home page associated with the current CM and a message to activate a browser, via the cooperating operation details transmission unit 111.

In the procedure 7d, the cooperating operation details reception unit 112 of the PC receives, from the DTV, the message to activate the browser and the URL associated with the CM as <Content ID>, and then presents the user with the homepage.

As described above, according to the seventh embodiment, the change of the device status is detected, and depending on the status change, the service associated with what the user is currently doing can be provided.

### Eighth Embodiment

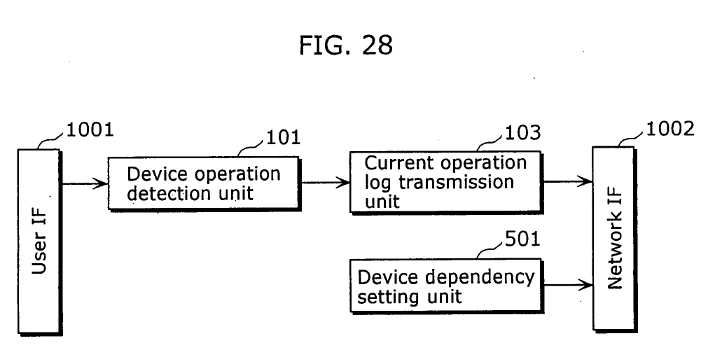

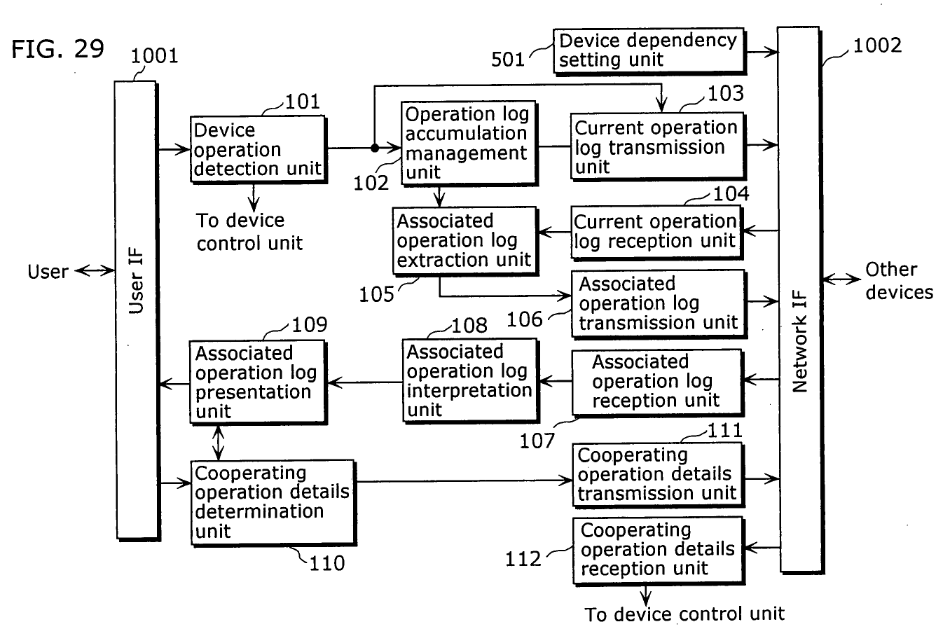

In the eighth embodiment, the device whose hardware resource is limited (for example, an MD compo) requests the device whose hardware resource is ample (for example, a PC) to substitutively accumulate operation logs and process cooperating operation details. FIG. 28 and FIG. 29 respectively show a structure diagram of the eighth embodiment. FIG. 28 is a block diagram showing the operation log cooperation utilizing device 100 in a device whose hardware resource is limited. And, FIG. 29 is a block diagram showing the operation log cooperation utilizing device 100 in a device whose hardware resource is ample. The difference from the first embodiment as shown in FIG. 2 is that there is an additional device dependency setting unit 501 for the substitute process (refer to FIG. 28 and FIG. 29).

Next, the operations of the device dependency setting unit 501 will be explained. For example, a device whose Central Processing Unit (CPU) speed is slow and memory size is small, such as an MD compo, sets the dependency when checking out the music downloaded in the PC to the MD. In other words, the operation logs of the MD compo are transmitted and accumulated into the PC every time they are generated, and the PC substitutively interprets and accumulates the operation logs of the other devices associated with the MD compo. Thus, even a cheap device can cooperate with the other devices.

As described above, according to the eighth embodiment, the device whose hardware resource is limited requests the device whose hardware resource is ample to substitutively accumulate and process the operation logs. Therefore, even a cheap device can easily cooperate with the other devices.

In the case where the user information such as a use history and a profile is managed all together, service cannot be received when a failure occurs, thus there is an even higher risk regarding security and privacy.

On the other hand, according to the eighth embodiment, (i) the operation logs of the plurality of devices are separately managed, (ii) each of the devices connected to each other substitutively execute operations such as the function to interpret the cooperating operation. Thereby, even in the case where any device is out f communication or broken due to failure, the device cooperation according to the user's situation can be achieved.

As described above, the operation log cooperation utilizing device according to the present invention has been explained based on the first to eighth embodiments. However, the present invention is not limited to these embodiments.

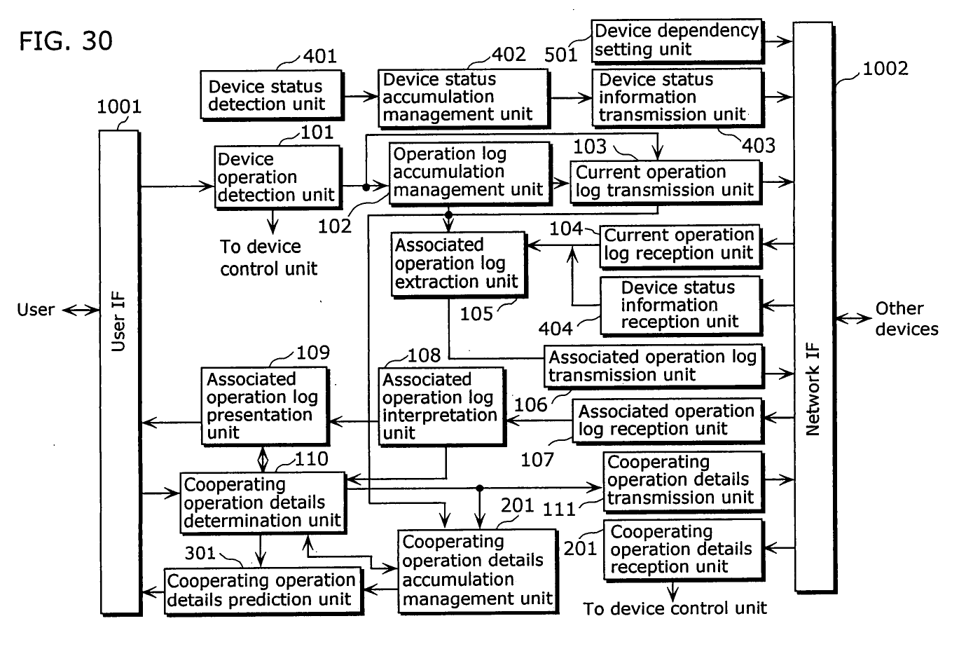

For example, an operation log cooperation utilizing device having a structure in which the above mentioned embodiments are combined can be an embodiment of the present invention. As an example, as shown in the structure example of FIG. 30, the present invention can be realized as an operation log cooperation utilizing device in which the first to eighth embodiments are combined.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention can be utilized as devices connected to each other via a network, for example, as home appliances which can be connected via a network, such as a DTV, a PC, a PDA, an MD compo, a DVD and HDD recorder.

1. An operation log cooperation utilizing device which allows a plurality of devices to cooperatively use user's operation logs accumulated in the plurality of devices, said operation log cooperation utilizing device comprising:
a device operation detection unit operable to detect a user's operation on a device;
an operation log accumulation management unit operable to accumulate and manage the detected operation along with a predetermined attribute as an operation log;
a current operation log transmission unit operable to transmit the current operation log as a current operation log to another device, the current operation log being accumulated when a user's operation is detected;
a current operation log reception unit operable to receive the current operation log transmitted from another device;
an associated operation log extraction unit operable to extract an operation log as an associated operation log from said operation log accumulation management unit, the operation log being in a predetermined relation to the received current operation log;
an associated operation log transmission unit operable to transmit the extracted associated operation log to another device;
an associated operation log reception unit operable to receive the associated operation log transmitted from another device;
an associated operation log interpretation unit operable to interpret the received associated operation log using a predetermined operation log interpretation method;
an associated operation log presentation unit operable to present the associated operation log to the user based on an interpretation result;
a cooperating operation details determination unit operable to determine cooperating operation details for another device using a predetermined log processing method based on the presented associated operation log;
a cooperating operation details transmission unit operable to transmit the determined cooperating operation details to a corresponding device; and
a cooperating operation details reception unit operable to receive the cooperating operation details from another device.

2. The operation log cooperation utilizing device according to claim 1,
wherein the predetermined attribute includes at least one combination among a date and time identifier, a device identifier, an operation identifier, a content identifier, an application identifier, a service identifier and a user identifier.

3. The operation log cooperation utilizing apparatus according to claim 1,
wherein the operation log which is in the predetermined relation to the received current operation log is an operation log whose accumulated time is within a predetermined time range.

4. The operation log cooperation utilizing device according to claim 1,
wherein in the predetermined operation log interpretation method, an association degree of a device and a device operation is calculated, the device and the device operation being associated with the user's current situation, and
said associated operation log presentation unit is operable to present the user with the associated operation log based on the association degree.

5. The operation log cooperation utilizing device according to claim 1,
wherein in the predetermined operation log interpretation method, the devices are ranked based on an operation frequency, and
said associated operation log presentation unit presents the user with the associated operation log based on the rank.

6. The operation log cooperation utilizing device according to claim 1,
wherein in the predetermined operation log interpretation method, logs are grouped based on an appearance frequency of an attribute value of the each predetermined attribute, and said associated operation log presentation unit presents the user with the associated operation log based on the grouping.

7. The operation log cooperation utilizing device according to claim 6,
wherein the associated operation log is presented to the user in an appearance frequency order of the attribute value.

8. The operation log cooperation utilizing device according to claim 1,
wherein in the predetermined log processing method, the presented log per se is selected.

9. The operation log cooperation utilizing device according to claim 1,
wherein in the predetermined log processing method, an attribute value of the selected log is updated.

10. The operation log cooperation utilizing device according to claim 1,
wherein in the predetermined log processing method, a plurality of attribute values are combined.

11. The operation log cooperation utilizing device according to claim 1, further comprising
a cooperating operation details accumulation management unit operable to accumulate and manage cooperating operation details for another device determined by the user along with a current operation log,
wherein said associated operation log presentation unit is operable to present cooperating operation details determined by the user in the past along with the associated operation log from another device.

12. The operation log cooperation utilizing device according to claim 1, further comprising
a cooperating operation details prediction unit operable to predict user's next cooperating operation details based on (i) at least one of the associated operation log received from another device and the cooperating operation details accumulated in said cooperating operation details accumulation management unit and (ii) a current operation log.

13. The operation log cooperation utilizing device according to claim 12,
wherein in the prediction by said cooperating operation details prediction unit, (i) the associated operation log received from another device and the cooperating operation details accumulated in said cooperating operation details accumulation management unit are grouped based on a predetermined attribute, and (ii) different attribute values between the grouped associated operation log and a current operation log are replaced.

14. The operation log cooperation utilizing device according to claim 1, further comprising
a device status detection unit operable to detect a device status in a predetermined timing;
a device status accumulation management unit operable to accumulate and manage device status information regarding the detected status;
a status information transmission unit operable to transmit the device status information to another device; and
a device status information reception unit operable to receive the device status information transmitted from another device,
wherein said associated operation log extraction unit operates using a reception of the device status information as a trigger.

15. The operation log cooperation utilizing device according to claim 1,
wherein the device status information is transmitted when the device status changes.

16. The operation log cooperation utilizing device according to claim 1, further comprising a device dependency relation setting unit operable for a device whose hardware resource is limited to request a device whose hardware resource is ample to accumulate an operation log and substitutively process a cooperating operation log.

17. An operation log cooperation utilizing method for allowing a plurality of devices to cooperatively use user's operation logs accumulated in the plurality of devices, said method comprising the following steps of:
detecting a user's operation on a device;
accumulating and managing the detected operation with a predetermined attribute as an operation log;
transmitting the current operation log as a current operation log to another device, the current operation log being accumulated when a user's operation is detected;
receiving the current operation log transmitted from another device;
extracting the operation log as an associated operation log from the operation log accumulated in said step of accumulating and managing the operation log, the operation log being in a predetermined relation to the received current operation log;
transmitting the extracted associated operation log to another device;
receiving the associated operation log transmitted from another device;
interpreting the received associated operation log using a predetermined operation log interpretation method;
presenting the associated operation log to the user based on an interpretation result;
determining cooperating operation details for another device using a predetermined log processing method based on the presented associated operation log;
transmitting the determined cooperating operation details to a corresponding device; and
receiving the cooperating operation details from another device.

18. A program for a device which allows a plurality of devices to cooperatively use user's operation logs accumulated in the plurality of devices, causing a computer to execute the steps included in the operation log cooperation utilizing method according to claim 17.

19. An operation log cooperation utilizing device which allows a plurality of devices to cooperatively use user's operation logs accumulated in the plurality of devices, the operation log cooperation utilizing device comprising:
a device operation detection unit operable to detect a user's operation on a device;
an operation log accumulation management unit operable to accumulate and manage the detected operation along with a predetermined attribute as an operation log;
a current operation log transmission unit operable to transmit the current operation log as a current operation log to another device, the current operation log being accumulated when a user's operation is detected;
an associated operation log reception unit operable to receive, from another device, an associated operation log which is in a predetermined relation to the transmitted current operation log;
an associated operation log interpretation unit operable to interpret the received associated operation log using a predetermined operation log interpretation method;
an associated operation log presentation unit operable to present the associated operation log to the user based on an interpretation result;
a cooperating operation details determination unit operable to determine cooperating operation details for another device using a predetermined log processing method based on the presented associated operation log; and
a cooperating operation details transmission unit operable to transmit the determined cooperating operation details to a corresponding device.

20. An operation log cooperation utilizing method for allowing a plurality of devices to cooperatively use user's operation logs accumulated in the plurality of devices, said operation log cooperation utilizing method comprising the following steps of:
detecting a user's operation on a device;
accumulating and managing the detected operation along with a predetermined attribute as an operation log;
transmitting the current operation log as a current operation log to another device, the current operation log being accumulated when a user's operation is detected;
receiving, from another device, an associated operation log which is in a predetermined relation to the transmitted current operation log;
interpreting the received associated operation log using a predetermined operation log interpretation method;
presenting the associated operation log to the user based on an interpretation result;
determining cooperating operation details for another device using a predetermined log processing method based on the presented associated operation log; and
transmitting the determined cooperating operation details to a corresponding device.

21. A program for a device which allows a plurality of devices to cooperatively use user's operation logs accumulated in the plurality of devices, causing a computer to execute the steps included in the operation log cooperation utilizing method according to claim 20.

22. An operation log cooperation utilizing apparatus which allows a plurality of devices to cooperatively use user's operation logs accumulated in the plurality of devices, said operation log cooperation utilizing device comprising:
a device operation detection unit operable to detect a user's operation on a device;
an operation log accumulation management unit operable to accumulate and manage the detected operation along with a predetermined attribute as an operation log;
a current operation log reception unit operable to receive the current operation log transmitted from another device;
an associated operation log extraction unit operable to extract an operation log as an associated operation log from said operation log accumulation management unit, the operation log being in a predetermined relation to a received current operation log;
an associated operation log transmission unit operable to transmit the extracted associated operation log to another device; and
a cooperating operation details reception unit operable to receive, from another device, cooperating operation details determined based on the transmitted associated operation log.

23. An operation log cooperation utilizing method for allowing a plurality of devices to cooperatively use user's operation logs accumulated in the plurality of devices, said operation log cooperation utilizing method comprising the following steps of:
detecting a user's operation on a device;
accumulating and managing the detected operation along with a predetermined attribute as an operation log;
receiving, as a current operation log, an operation log transmitted from another device;
extracting an operation log as an associated operation log from the operation log accumulated in said step of accumulating and managing the operation log, the operation log being in a predetermined relation to the received current operation log;
transmitting the extracted associated operation log to another device; and
receiving, from another device, cooperating operation details determined based on the transmitted associated operation log.

24. A program for a device which allows a plurality of devices to cooperatively use user's operation logs accumulated in the plurality of devices, said program causing a computer to execute the steps included in the operation log cooperation utilizing method according to claim 23.

25. An operation log cooperation utilizing device which allows a plurality of devices to cooperatively use user's operation logs accumulated in the plurality of devices, the operation log cooperation utilizing device comprising:
a device operation detection unit operable to detect a user's operation on a device;
an operation log accumulation management unit operable to accumulate and manage the detected operation along with a predetermined attribute as an operation log;
a current operation log transmission unit operable to transmit the current operation log as a current operation log to another device, the current operation log being accumulated when a user's operation is detected;
an associated operation log reception unit operable to receive an associated operation log transmitted from another device;
an associated operation log interpretation unit operable to interpret the received associated operation log using a predetermined operation log interpretation method;
a cooperating operation details determination unit operable to determine cooperating operation details for another device using a predetermined log processing method based on the interpreted associated operation log; and
a cooperating operation details transmission unit operable to transmit the determined cooperating operation details to a corresponding device.

26. An operation log cooperation utilizing method for allowing a plurality of devices to cooperatively use user's operation logs accumulated in the plurality of devices, said operation log cooperation utilizing method comprising the following steps of:
detecting a user's operation on a device;
accumulating and managing the detected operation with a predetermined attribute as an operation log;
transmitting the current operation log as a current operation log to another device, the current operation log being accumulated when a user's operation is detected;
receiving an associated operation log transmitted from another device, the associated operation log being in a predetermined relation to the transmitted current operation log;
interpreting the received associated operation log using a predetermined operation log interpretation method;
determining cooperating operation details for another device using a predetermined log processing method based on the interpreted associated operation log; and
transmitting the determined cooperating operation details to a corresponding device.
